(19) United States
(12) Patent Application Publication
(10) Pub. No.: US 2019/0232743 A1
(43) Pub. Date: Aug. 1, 2019

(54) BABY-ON-BOARD TRAILER HITCH COVER ASSEMBLY AND METHOD

(71) Applicants: Steve Tuthill, Sacramento, CA (US); Renee Tuthill, Sacramento, CA (US)

(72) Inventors: Steve Tuthill, Sacramento, CA (US); Renee Tuthill, Sacramento, CA (US)

(21) Appl. No.: 16/262,572

(22) Filed: Jan. 30, 2019

Related U.S. Application Data
(60) Provisional application No. 62/623,793, filed on Jan. 30, 2018.

(51) Int. Cl. B60D 1/60; G09F 7/18; B60R 3/00

(52) U.S. Cl. CPC B60D 1/60; G09F 7/18; G09F 2007/1873; G09F 2007/1865; B60R 3/007

(57) ABSTRACT

A baby-on-board trailer hitch cover assembly; the baby-on-board trailer hitch cover assembly includes a board, a tube-hitch-insert, and a doll. The baby-on-board trailer hitch cover assembly is useful for providing drivers or users with a novelty sign designed to bring public awareness to the fact that there is a baby or small child inside a vehicle.

### CROSS-REFERENCE TO RELATED APPLICATION(S)

The present application is related to and claims priority to U.S. Provisional Patent Application No. 62/623,793 filed 30 Jan. 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of trailer hitch covers of existing art and more specifically relates to a trailer hitch cover for displaying warning language.

### RELATED ART

When traveling by a vehicle such as a car, many parents may feel that other drivers are operating their vehicles recklessly by driving too fast or too close to other vehicles. Indicating to other drivers that there are babies or children on board the vehicle can have an immediate effect, possibly causing them to slow down or proceed with caution. This may help reduce the chances of a collision and improve safety on the road. Prior attempts to warn drivers of babies and children on board include stickers placed on windows or bumpers. These stickers can be difficult to be removed or reapplied when desired requiring drivers to permanently display these signs. Therefore, a suitable solution is desired that is effective and not distracting.

U.S. Pub. No. 2017/0326931 to Rene Carl Batiste relates to a flexible trailer hitch receiver display sign. The described flexible trailer hitch receiver display sign includes a flexible decorative display device for attachment to a hitch receiver. The flexible display device is formed from a bendable sheet having a distal front surface, a proximal rear surface, an outer shaped outline, and interior shaped edges. The interior shaped edges form both a central opening to accommodate the trailer hitch receiver and a tongue. The tongue has tongue alignment cavity edges that define an interior tongue pin-receiving cavity. The tongue bends backwardly at a flexure line to fold back over the outside of the receiver tube, aligning the tongue pin-receiving cavity with the pin-receiving hole of the receiver.

### SUMMARY OF THE INVENTION

In view of the foregoing disadvantages inherent in the known display signs for a “baby on board” art, the present disclosure provides a novel baby-on-board trailer hitch cover assembly and method. The general purpose of the present disclosure, which will be described subsequently in greater detail, is to provide a display for a trailer hitch cover to notify other drivers that a baby is on board a vehicle (or other such desired warning).

A baby-on-board trailer hitch cover assembly is disclosed herein. The baby-on-board trailer hitch cover assembly includes a board including a front, a back, and a side perimeter. The side perimeter may circumscribe and extend between the front and the back. The side perimeter may further be defined by a bottom side opposite a top side, and a left side opposite a right side. A tube-hitch-insert may be provided including a first-end and a second-end. The first-end is configured to be attached to the board and the second-end is configured to be inserted into a receiver trailer hitch on a vehicle. The baby-on-board trailer hitch cover assembly may further include a doll fastened to the front of the board.

According to another embodiment, a method of using a baby-on-board trailer hitch cover assembly is also disclosed herein. The method includes a providing a baby-on-board trailer hitch cover assembly as describe above, mounting the baby-on-board trailer hitch cover assembly to the receiver trailer hitch, and warning other drivers that a baby is on board the vehicle via the baby-on-board trailer hitch cover assembly.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a baby-on-board trailer hitch cover assembly and method, constructed and operative according to the teachings of the present disclosure.

FIG. 1 is a perspective view of the baby-on-board trailer hitch cover assembly during, according to an embodiment of the disclosure.

FIG. 2 is a front view of the baby-on-board trailer hitch cover assembly of FIG. 1, according to an embodiment of the present disclosure.

FIG. 3 is a perspective side view of the baby-on-board trailer hitch cover assembly of FIG. 1, according to an embodiment of the present disclosure.

FIG. 4 is a front view of the baby-on-board trailer hitch cover assembly of FIG. 1, according to an embodiment of the present disclosure.

FIG. 5 is a flow diagram illustrating a method of using a baby-on-board trailer hitch cover assembly, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to displays for notifying other drivers that a baby is on board a vehicle and more particularly to a baby-on-board trailer hitch cover assembly and method as used to improve the vehicle safety around the vehicle that a baby is on board of.

Generally, present invention provides drivers with a novelty sign designed to bring public awareness to the fact that there is a baby or small child inside the vehicle. It enables drivers to convey to others on the road to use extra caution within close proximity to their vehicle. The baby-on-board trailer hitch cover assembly may offer a way for parents to indicate that they are transporting one or more children or babies. It assists in reducing the chances of a traffic collision caused by reckless driving by warning others to slow down and use caution. The present invention may also double as a step to assist users with accessing the bed of a truck or SUV.

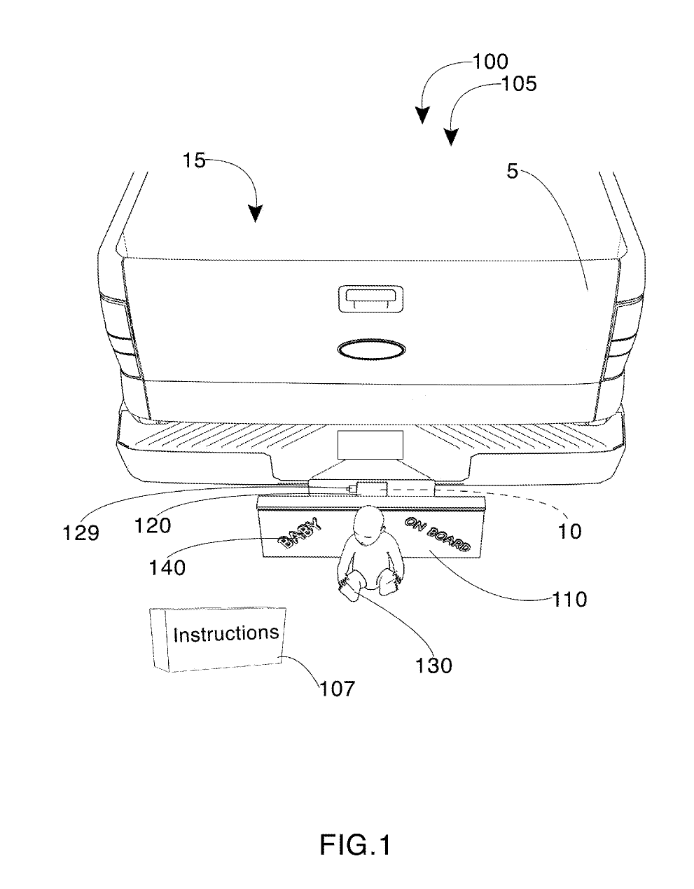

Referring now more specifically to the drawings by numerals of reference, there is shown in FIGS. 1-4, various views of a baby-on-board trailer hitch cover assembly 100.

FIG. 1 shows a baby-on-board trailer hitch cover assembly 100, according to an embodiment of the present disclosure. Here, baby-on-board trailer hitch cover assembly 100 may be beneficial for use by a user 40 to attach a display sign to a receiver trailer hitch 10 on a vehicle 5. As illustrated, the baby-on-board trailer hitch cover assembly 100 may include a board 110 including a front 111, a back (not shown), and a side perimeter 113. The side perimeter 113 may circumscribe and extend between the front 111 and the back. The side perimeter 113 may further be defined by a bottom side 114 opposite a top side 115, and a left side 116 opposite a right side 117. A tube-hitch-insert 120 may be provided including a first-end 122 and a second-end 124. The first-end 122 is configured to be attached to the board 110 and the second-end 124 is configured to be inserted into the receiver trailer hitch 10 on the vehicle 5. The baby-on-board trailer hitch cover assembly 100 may further include a doll 130 fastened to the front 111 of the board 110. The present invention may offer a way (means) for users to convey to others that they are traveling with a baby.

According to one embodiment, the baby-on-board trailer hitch cover assembly 100 may be arranged as a kit 105. In particular, the baby-on-board trailer hitch cover assembly 100 may further include a set of instructions 107. The instructions 107 may detail functional relationships in relation to the structure of the baby-on-board trailer hitch cover assembly 100 such that the baby-on-board trailer hitch cover assembly 100 can be used, maintained, or the like, in a preferred manner.

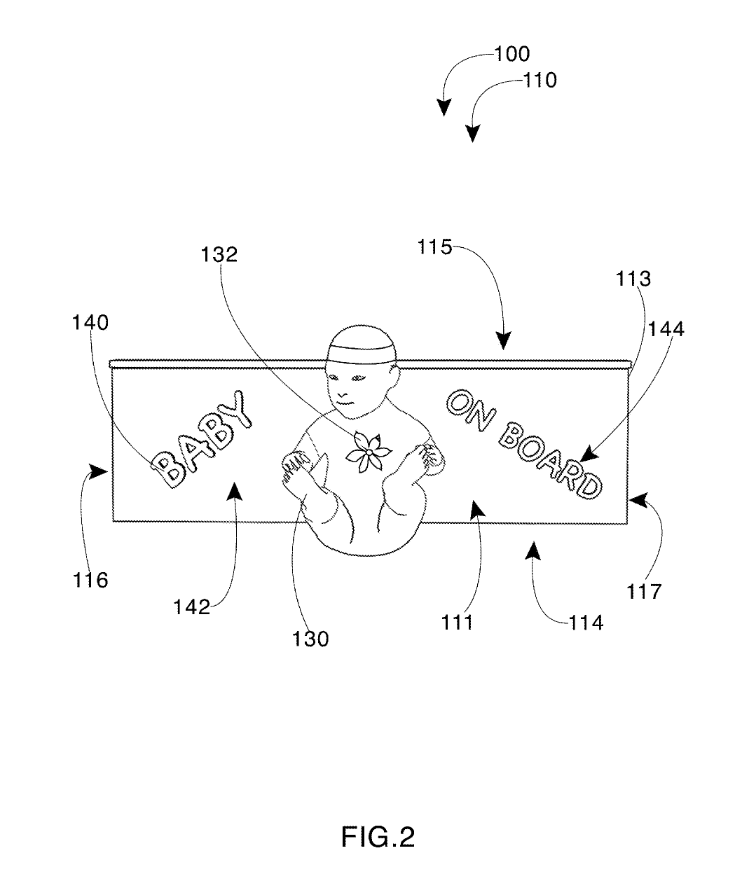

FIG. 2 shows the baby-on-board trailer hitch cover assembly 100 of FIG. 1, according to an embodiment of the present disclosure. As above, the baby-on-board trailer hitch cover assembly 100 may include the board 110 including the front 11, the back, and the side perimeter 113. The side perimeter 113 may circumscribe and extend between the front 111 and the back. The side perimeter 113 may further be defined by the bottom side 114 opposite the top side 115, and the left side 116 opposite the right side 117. The board 110 may be a planar rectangular board, a skate board, a surf board, a wake board, a snow board, a ski board, or a combination thereof.

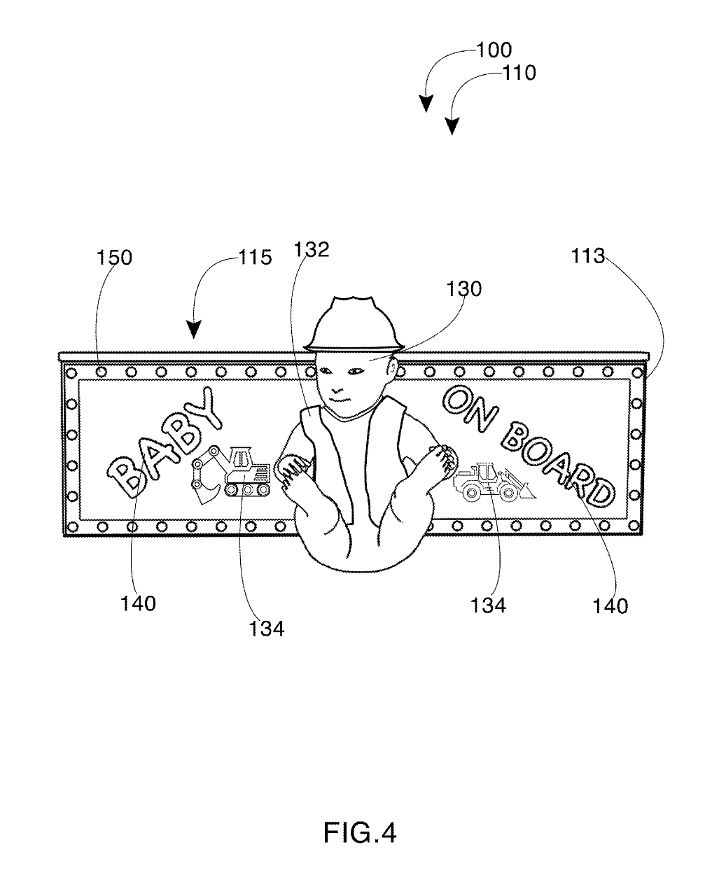

The baby-on-board trailer hitch cover assembly 100 may include the (functional) doll 130 fastened to the front 111 of the board 110. The doll 130 may preferably be a baby doll. One or more pieces of apparel 132 may be attachable to (or otherwise worn on) the baby doll. The pieces of apparel 132 may include but not be limited to shirts, pants, shorts, hats, dresses, and shoes. In some aspects, the pieces of apparel 132 may correspond to a theme, event, and/or occupation (e.g. sports team, religion, etc.). One or more accessory items 134 (as shown in FIG. 4) may also be attachable to the board 110 and the baby doll. The accessory items 134 may enhance or be related to the pieces of apparel 132. The accessory items 134 may include sports balls, toy trucks, toy guns, and other such items that are small sized and are functional in utility.

The front 111 of the board 110 may further include (functional) indicia 140. The indicia 140 can be positioned on a left-side 142 and a right-side 144 of the doll 130. The indicia 140 may include warning language. Preferably, the warning language reads “Baby On Board”. However, other such language that conveys the same message may be used (i.e., “Future Pope On Board”). In addition, the indicia 140 can be provided in any language, including but limited to: English, Spanish, Italian, French, and the like.

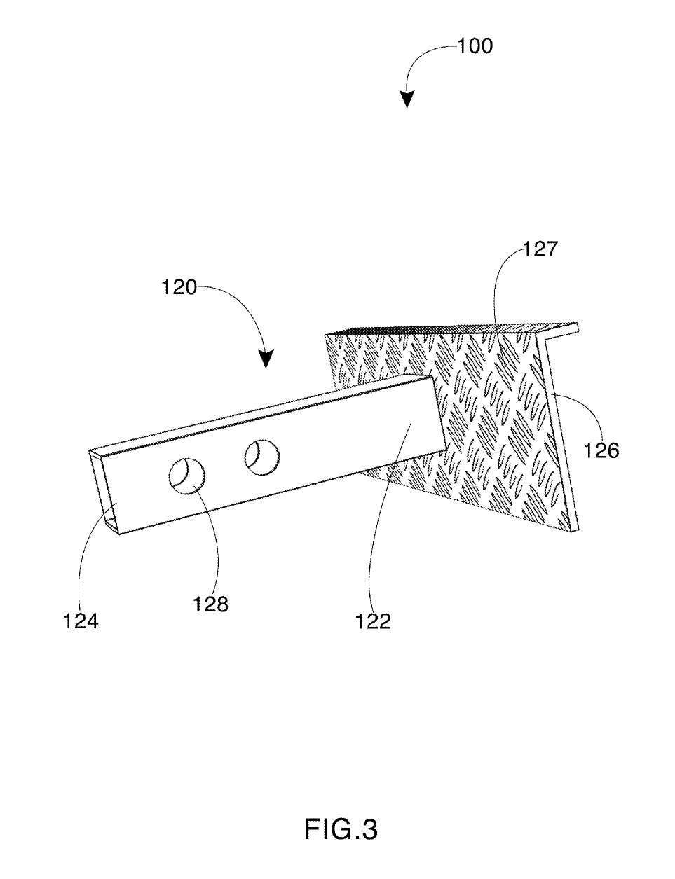

FIG. 3 is a perspective side view of the baby-on-board trailer hitch cover assembly 100 of FIG. 1, according to an embodiment of the present disclosure. As described above, the baby-on-board trailer hitch cover assembly 100 may include the tube-hitch-insert 120 including the first-end 122 and the second-end 124. The first-end 122 may be configured to be attached to the board 110 and the second-end 124 may be configured to be inserted into the receiver trailer hitch 10 on the vehicle 5. The second-end 124 may include at least one aperture 128 extending through the tube-hitch insert 120. The aperture 128 may be configured to receive a fastener 129 such as a pin to secure the tube-hitch-insert 120 into the receiver trailer hitch 10 (as shown in FIG. 1).

The tube-hitch-insert 120 may include an L-shaped mounting plate 126 at the first-end 122. The L-shaped mounting plate 126 may be configured to attach over the back and the top side 115 of the board 110. The L-shaped mounting plate 126 may include a frictional surface 127. The frictional surface 127 may be provided by ridges, grooves, or otherwise raised surfaces on the L-shaped mounting plate 126. The frictional surface 127 may be configured to provide a step for the user on the top side 115 of the board. The step can assist users with accessing the vehicle's bed 15 (as shown in FIG. 1).

FIG. 4 is a front view of the baby-on-board trailer hitch cover assembly 100 of FIG. 1, according to an embodiment of the present disclosure. The baby-on-board trailer hitch cover assembly 100 may further comprise one or more light emitting diode (LED) strips 150 attachable to the board 110. The LED strips 150 may be attached around the side perimeter 113 or only to the top side 115. The LED strips 150 may include colored diodes and be attachable via a variety of ways including adhesive, hardware, and other known means.

The LED strips 150 may be electrically connected to the vehicle's 5 electrical tow package system (or otherwise known as the electrical lighting circuit) and is configured to provide illumination when one or more lights on the vehicle 5 are activated (e.g., brake lights, running lights, etc.). Connecting means may include a cord having a plug to electrically connect to the vehicle's 5 electrical tow package system. Those with ordinary skill in the art will now appreciate that upon reading this specification and by their understanding the art of connectors as described herein, methods of connecting to the vehicle's 5 electrical tow package system will be understood by those knowledgeable in such art.

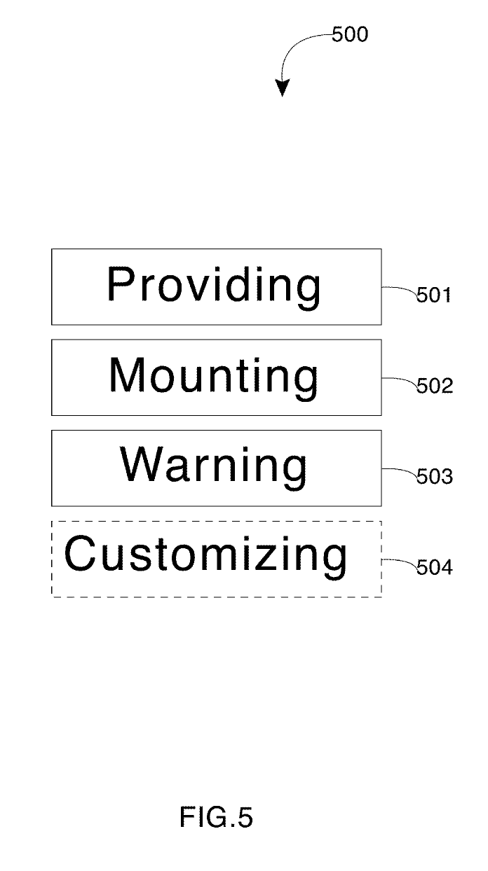

FIG. 5 is a flow diagram illustrating a method for using a baby-on-board trailer hitch cover assembly 500, according to an embodiment of the present disclosure. In particular, the method for using the baby-on-board trailer hitch cover assembly 500 may include one or more components or features of the baby-on-board trailer hitch cover assembly 100 as described above. As illustrated, the method for using the baby-on-board trailer hitch cover assembly 500 may include the steps of: step one 501, providing a baby-on-board trailer hitch cover assembly 100 including a board 110 including a front 111, a back 112, and a side perimeter 113, the side perimeter 113 circumscribing and extending between the front 111 and the back, the side perimeter 113 defined by a bottom side 114 opposite a top side 115, and a left side 116 opposite a right side 117, a tube-hitch-insert 120 including a first-end 122 and a second-end 124 , the first-end 122 is configured to be attached to the board 110 and the second-end 124 is configured to be inserted into a receiver trailer hitch 10 on a vehicle 5, and a doll 130 fastened to the front 111 of the board 110; step two 502, mounting the baby-on-board trailer hitch cover assembly 100 to the receiver trailer hitch 10; step three 503, warning other drivers that a baby is on board the vehicle 5 via the baby-on-board trailer hitch cover assembly 100; and step four 504, customizing the doll 130 with one or more pieces of apparel 132 and accessories items 134.

It should be noted that step four 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the baby-on-board trailer hitch cover assembly 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A baby-on-board trailer hitch cover assembly, the assembly comprising:
a board including a front, a back, and a side perimeter, the side perimeter circumscribing and extending between the front and the back, the side perimeter defined by a bottom side opposite a top side, and a left side opposite a right side;
a tube-hitch-insert including a first-end and a second-end, the first-end is configured to be attached to the board and the second-end is configured to be inserted into a receiver trailer hitch on a vehicle; and
a doll fastened to the front of the board.

2. The baby-on-board trailer hitch cover assembly of claim 1, wherein the tube-hitch-insert includes an L-shaped mounting plate at the first-end, the L-shaped mounting plate is configured to attach over the back and the top side of the board.

3. The baby-on-board trailer hitch cover assembly of claim 2, wherein the L-shaped mounting plate includes a frictional surface.

4. The baby-on-board trailer hitch cover assembly of claim 3, wherein the frictional surface is configured to provide a step for a user on the top side of the board.

5. The baby-on-board trailer hitch cover assembly of claim 1, wherein the second-end includes at least one aperture extending through the tube-hitch insert, the aperture is configured to receive a fastener to secure the tube-hitch-insert into the receiver trailer hitch.

6. The baby-on-board trailer hitch cover assembly of claim 1, wherein the board is a planar rectangular board, a skate board, a surf board, a wake board, a snow board, a ski board, or a combination thereof.

7. The baby-on-board trailer hitch cover assembly of claim 1, wherein the doll is a baby doll.

8. The baby-on-board trailer hitch cover assembly of claim 1, wherein one or more pieces of apparel are attachable to the baby doll.

9. The baby-on-board trailer hitch cover assembly of claim 8, wherein one or more accessory items are attachable to the board and the baby doll.

10. The baby-on-board trailer hitch cover assembly of claim 9, wherein the pieces of apparel and the accessory items are adhesively attached.

11. The baby-on-board trailer hitch cover assembly of claim 1, wherein the front of the board includes indicia, the indicia positioned on a left-side and a right-side of the doll.

12. The baby-on-board trailer hitch cover assembly of claim 11, wherein the indicia includes warning language.

13. The baby-on-board trailer hitch cover assembly of claim 1, further comprising one or more light emitting diode (LED) strips attachable to the board.

14. The baby-on-board trailer hitch cover assembly of claim 13, wherein the LED strips are attached around the side perimeter.

15. The baby-on-board trailer hitch cover assembly of claim 14, wherein the LED strips are attached to the top side.

16. The baby-on-board trailer hitch cover assembly of claim 15, wherein the LED strips are electrically connected to the vehicle's electrical tow package system and is configured to provide illumination when one or more lights on the vehicle are activated.

17. A baby-on-board trailer hitch cover assembly comprising:
a board including a front, a back, and a side perimeter, the side perimeter circumscribing and extending between the front and the back, the side perimeter defined by a bottom side opposite a top side, and a left side opposite a right side;
a tube-hitch-insert including a first-end and a second-end, the first-end is configured to be attached to the board and the second-end is configured to be inserted into a receiver trailer hitch on a vehicle;
a doll fastened to the front of the board;
wherein the tube-hitch-insert includes an L-shaped mounting plate at the first-end, the L-shaped mounting plate is configured to attach over the back and the top side of the board;
wherein the L-shaped mounting plate includes a frictional surface;
wherein the frictional surface is configured to provide a step for a user on the top side of the board;
wherein the second-end includes at least one aperture extending through the tube-hitch insert, the aperture is configured to receive a fastener to secure the tube-hitch-insert into the receiver trailer hitch;
wherein the board is a planar rectangular board, a skate board, a surf board, a wake board, a snow board, a ski board, or a combination thereof;
wherein the doll is a baby doll;
wherein one or more pieces of apparel are attachable to the baby doll;
wherein one or more accessory items are attachable to the board and the baby doll;
wherein the pieces of apparel and the accessory items are adhesively attached;
wherein the front of the board includes indicia, the indicia positioned on a left-side and a right-side of the doll;
wherein the indicia includes warning language;
wherein one or more light emitting diode (LED) strips attachable to the board;
wherein the LED strips are attached around the side perimeter; and
wherein the LED strips are electrically connected to the vehicle's electrical tow package system and is configured to provide illumination when one or more lights on the vehicle are activated.

18. The baby-on-board trailer hitch cover assembly of claim 17, further comprising set of instructions; and
wherein the baby-on-board trailer hitch cover assembly is arranged as a kit.

19. A method of using a baby-on-board trailer hitch cover assembly, the method comprising the steps of:
providing a baby-on-board trailer hitch cover assembly including
a board including a front, a back, and a side perimeter, the side perimeter circumscribing and extending between the front and the back, the side perimeter defined by a bottom side opposite a top side, and a left side opposite a right side,
a tube-hitch-insert including a first-end and a second-end, the first-end is configured to be attached to the board and the second-end is configured to be inserted into a receiver trailer hitch on a vehicle, and
a doll fastened to the front of the board;
mounting the baby-on-board trailer hitch cover assembly to the receiver trailer hitch; and
warning other drivers that a baby is on board the vehicle via the baby-on-board trailer hitch cover assembly.

20. The method of claim 19, further comprising the steps of customizing the functional doll with one or more pieces of apparel and accessory items.
